(19) United States
(12) Patent Application Publication
(10) Pub. No.: US 2018/0326236 A1
(43) Pub. Date: Nov. 15, 2018

(54) SPARK ARRESTOR

(71) Applicant: RoboVent Products Group, Inc., Sterling Heights, MI (US)

(72) Inventors: John Reid, Troy, MI (US); James Reid, Blacklick, OH (US); Michael Hattingh, Troy, MI (US)

(21) Appl. No.: 15/977,935

(22) Filed: May 11, 2018

Related U.S. Application Data
(60) Provisional application No. 62/505,639, filed on May 12, 2017.

(51) Int. Cl. A62C 4/00; B01D 45/12; B04C 3/06; B01D 46/30; B01D 46/24; B01D 46/00

(52) U.S. Cl. CPC A62C 4/00; B01D 45/12; B04C 3/06; B04C 2003/003; B01D 46/2403; B01D 46/0093; B01D 46/30

(57) ABSTRACT

The present invention is a spark arrestor and method of using. The spark arrestor has a first chamber defined by an outer housing. The outer housing has an intake and an exhaust. The first chamber has an internal second chamber. An internal housing defines the second chamber. The internal housing has an inlet and an outlet. The internal housing inlet has a plurality of openings in fluid communication with the first airflow path and the outlet is in operative communication with the exhaust. The outer housing and the internal housing are spaced apart to create a first airflow path. The internal housing creates a second airflow path in said second chamber. The intake pulls air with entrained particulates into the first airflow path and then it enters the inlets and flows about the second airflow path with any entrained particulates engaging the outer and internal housing.

### RELATED APPLICATIONS

This application claims the benefit of U.S. Provisional Application No. 62/505,639 filed on May 12, 2017, which is incorporated herein in its entirety.

### STATEMENT REGARDING FEDERALLY SPONSORED RESEARCH

NONE.

### TECHNICAL FIELD

This invention relates generally to spark arrestor units and particularly to spark arrestor units used in connection with air filter systems.

### BACKGROUND OF THE INVENTION

Manufacturing facilities, particularly those that perform welding, cutting and grinding operations, commonly use air-filtering systems. For example, in a typical welding station located within a manufacturing facility, there is a direct connection, usually through ducting, to an air filtering system. The air filtering system pulls air from the welding station through a series of air filters having filter medium and then discharges the filtered air back into the facility.

One problem with filtering air from for example a welding, cutting, or grinding operation is that the air has entrained material that can include sparks. If these sparks are pulled into the filtering material they can cause fires. Typically, a spark arrestor is mounted between the source of the sparks and the filter medium within the filtering unit to capture the sparks so that they cannot enter the filter medium. The spark arrestor is mounted near the source of the sparks, at the intake into the ductwork, or as part of the ductwork system between the intake point and the filtering unit, or at the point where the air enters the filtering unit.

A common spark arrester is a series of screens that attempt to capture the spark before the spark can enter the filter medium. Screen type spark arresters have several disadvantages, including the need for regular maintenance that requires either replacement of the screens or cleaning of the screens. It is very common for the captured sparks to clog the filter screens. Additionally, contaminants and particulates within the air can further clog the screen reducing the flow of air to the filters. Additionally, screens are typically ineffective at capturing and/or cooling the sparks before they enter the filter material. Additionally, if the captured sparks and particulates are not cleaned off regularly, they can provide the fuel for a fire to start when a spark comes in contact with them.

U.S. Pat. Nos. 7,416,573 and 7,588,611 show another style of spark arrestor. This style forces the sparks into a series of radially extending blades to attempt to cool the spark before the spark can enter the filter medium. This style still allows some sparks to reach the filter medium. Their design reduces airflow through the filter medium due to the blades restricting airflow. They also cause the motor and blower to consume more energy in performing their work, due to the restricted airflow.

It is desirable to provide a more efficient spark arrestor that captures and extinguishes sparks, reduces maintenance and has no adverse impact the air filter system.

### SUMMARY OF THE INVENTION

Generally, the present invention provides a spark arrestor that removes heat and energy from sparks as part of an industrial ventilation system. For example, manual or robotic welding operations, grinding or metal cutting, or plasma or laser cutting tables or robots use industrial ventilation systems. All of these operations can produce sparks.

In the disclosed invention, air enters a first chamber through an intake, in a manner to induce rapid rotation. Centrifugal force forces the particulate and sparks in the airstream into the walls of the chamber. The contact between the spark and the chamber of the device extinguishes the spark. Conduction removes heat and energy from the spark due to contact with the lower temperature surface of the device. The spark contacting the surfaces of the device disrupts the high-energy envelope that surrounds the spark to aid in extinguishing the spark. Larger sparks break into multiple smaller sparks to extinguish much faster.

The air then enters a second chamber through openings. In the disclosed embodiment, these openings are slots. As further disclosed, the slots are wider in the center and narrow from the center to the ends. The second chamber creates a second air path that rotates. As with the first chamber, centrifugal force forces the remaining particulate and sparks in the airstream into the walls of the second chamber with the same results. In addition, the airflow through the slots creates further turbulence and cools any remaining sparks. The air exits the second chamber through an exhaust where it can then enter the air filter system.

Larger cooled particles do not enter the second chamber due to the rapid rotation and centrifugal force keeping them close to the outer walls of the first chamber. Instead of exiting the spark arrestor through the exhaust duct, they drop down though the intake, which eliminates the issue of particles accumulating inside the spark asrrestor.

The present invention solves the problem of the lit spark being conveyed at high velocity into the dust collector filter plenum, where it can potentially start a fire. The present invention solves the problem of particulate accumulating on spark arresting screens, which require periodic maintenance. The present invention requires little or no maintenance to keep free of accumulating particulate. The present invention also maintains consistent airflow to the filters and provides for more efficient blower operation.

These and other features and advantages of this invention will become more apparent to those skilled in the art from the detailed description of a preferred embodiment. Described below are the drawings that accompany the detailed description.

### BRIEF DESCRIPTION OF THE DRAWINGS

FIG. 1 is a perspective view of an example of an air filter system with the spark arrestor of the present invention.

FIG. 2 is a perspective view of the spark arrestor if the present invention.

FIG. 3 is a bottom view of the spark arrestor of the present invention with the internal chamber shown in phantom.

FIG. 4 is a cross sectional view of the spark arrestor if the present invention.

### DETAILED DESCRIPTION OF A PREFERRED EMBODIMENT

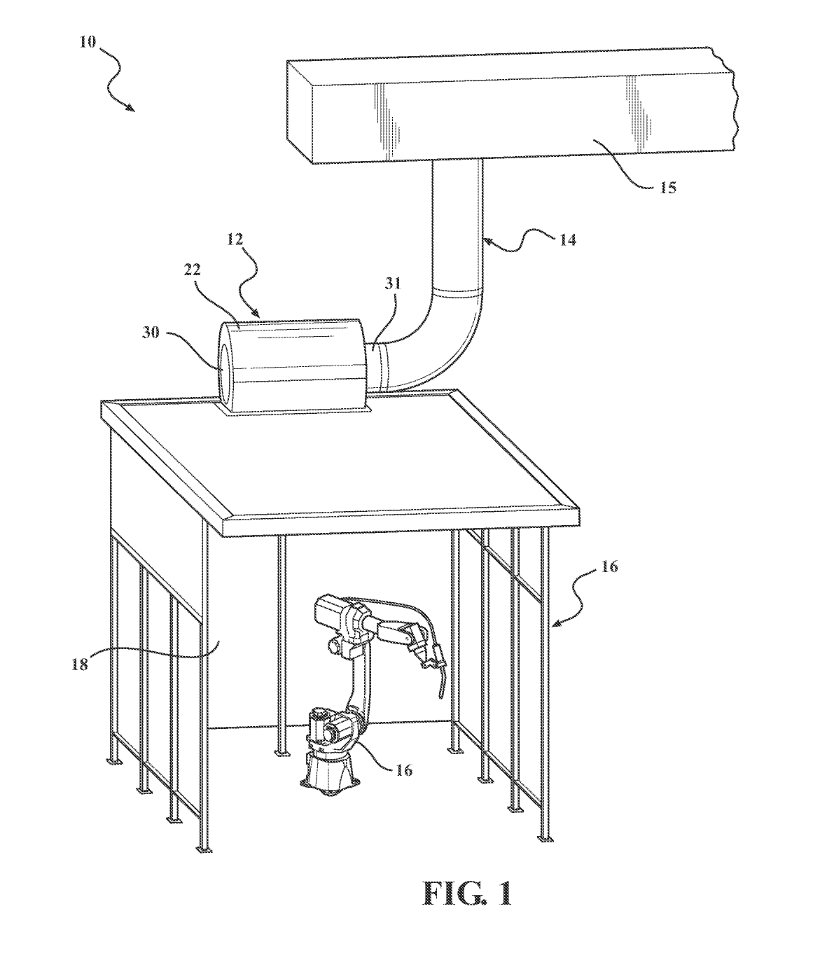

The spark arrester of the present invention is generally shown at 12. In FIG. 1, the spark arrester 12 is illustrated on a typical welding station 10. In the disclosed embodiment, the spark arrester 12 is mounted on top of the welding station 10 and connected to ducting 14 which is in turn connected to an air filter system 15, shown as a block diagram. Those of ordinary skill in the art will understand that any typical air filter will function with the disclosed system. As illustrated, a robotic welding unit 16 is located in welding station 10; however, it will be appreciated by those of ordinary skill in the art that other types of equipment could be mounted within the enclosure as well as other operations performed either by robots or humans.

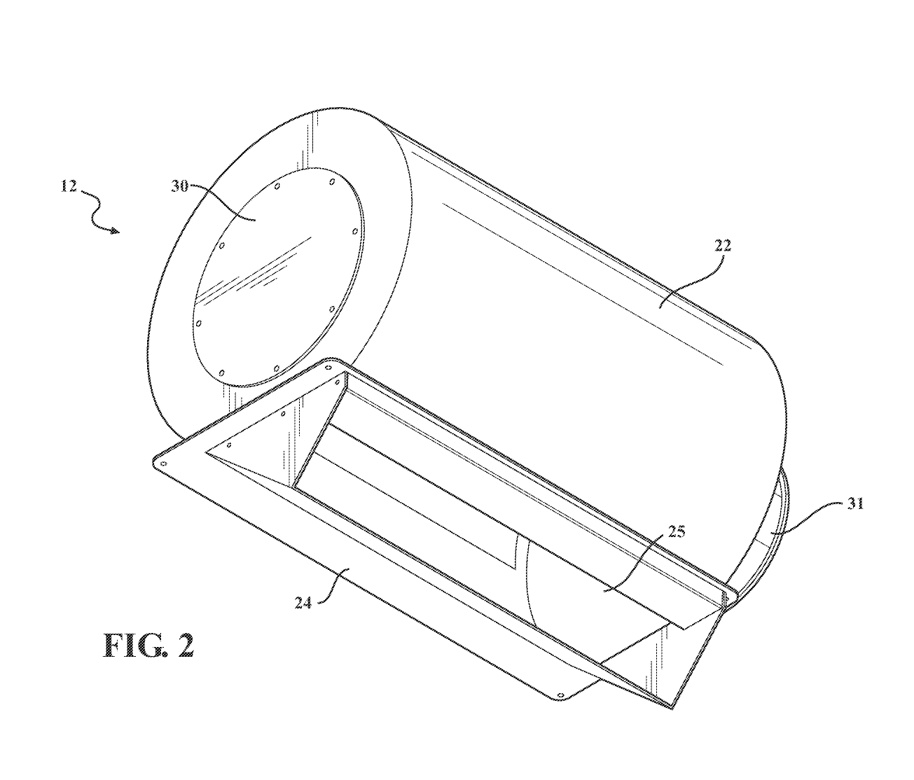

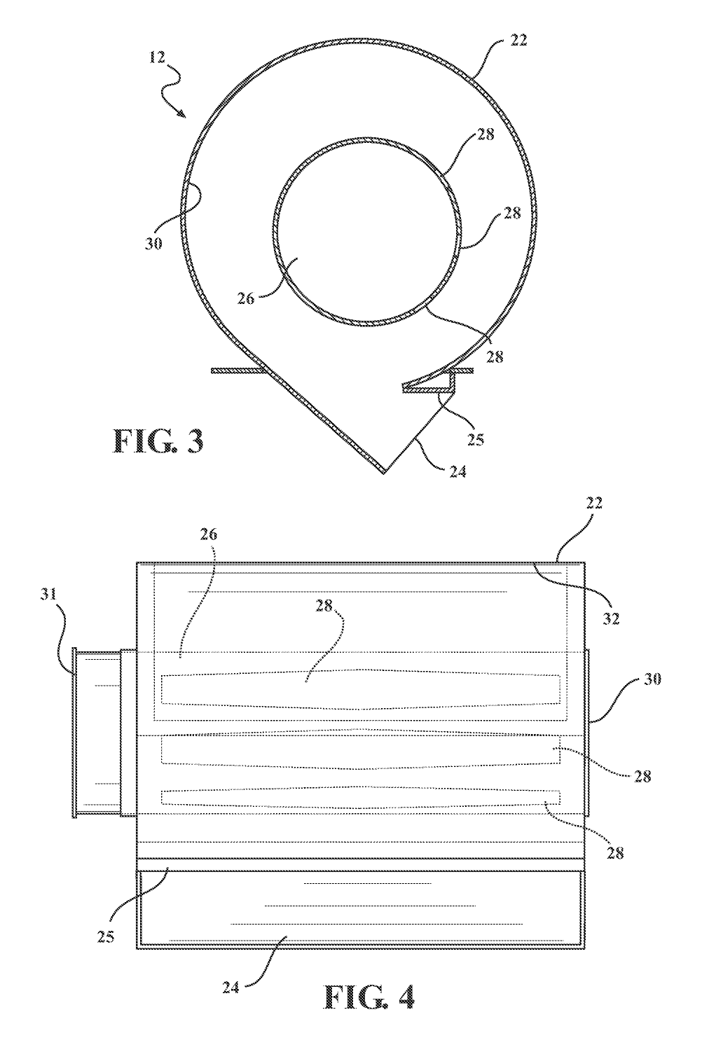

In FIGS. 2 and 3, the spark arrester 12 is illustrated. As will be appreciated by those of ordinary skill in the art, the spark arrester 12 is versatile and can be used in many operations that require drawing air with potential sparks, particularly in air filtration systems, such as weld stations, backdrafts, grinding centers, etc.

With reference to FIGS. 2 and 3, the spark arrester 12 includes an outer housing 22 and internal chamber 26. A first path is defined between the housing 24 and the internal chamber 26. An inlet 24 is in operative communication with the first path. The internal chamber 26 defines a second path. The internal chamber 26 has at least one opening 28 disclosed as plurality of longitudinal extending slots 28 in fluid communication between the first and second paths. In the disclosed embodiment, there are three slots 28. The slots 28 are spaced from the opening 24 starting at about 270° (270 degrees) from the opening 24. A plate 30 closes one side of the internal chamber 26. The other side of the internal chamber 26 is operatively connected to the ducting 14, through an outlet 31.

In use, the ducting 14 is connected directly to an air filter system 15. Such systems are sold by the assignee of the present application, Robovent. The air filter system has a blower that creates a vacuum in the ducting 14 to draw air from the workstation or backdraft. Depending on the operation, this air can have sparks that can create a potential fire hazard if they reach the air filtering system. In order to extinguish the sparks, the air and entrained sparks are drawn into the spark arrestor through the inlet 24. The negative pressure or vacuum created by the air filtering system is connected directly to the internal chamber 26 which is in communication with the first path and outer housing 22 through the slots 28.

This vacuum pulls the air with the entrained sparks and other particulate into the inlet 24 along the first path resulting in the sparks and other entrained material colliding with the inside surface 32 of the outer housing 22. The collision of the sparks with the inside surface 32 of the outer housing 22 lowers the energy of the sparks and results in their cooling as they are pulled through the first path. A plate 25 extends across and partially closes opening 24. The air entering the narrowed opening at plate 25 accelerates to force the air in the counterclockwise direction. This results in the air and the entrained particulate traversing at least three quarters of the housing 22 before encountering the slots 28. The heavier particulate entrained in the air engages the inner wall of the housing 22 and falls to the opening 24 and exits the spark arrestor 12.

As air is pulled through the slots 28 into the second path back to the air filter 15. Some of the cooled sparks and other entrained particulate are too large and are restricted from entering the slots 28 towards the center of the chamber due to their higher mass and centrifugal force keeping them closer to the walls of the outer housing 22. These particulates drop downwardly through the inlet 24 and exit the spark arrester 12 through the inlet. The only particulate that can enter the slots 28 are very small and are captured by the air filter 15. The air that is in the internal chamber 26 has a higher velocity and pulls any small particulate to the filter 15 to keep the internal chamber free of particulate. The small particulate engages the walls of the internal chamber 26 as they are pulled to the filter.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A spark arrestor comprising:
a first chamber defined by an outer housing; said outer housing having an intake and an exhaust;
a second chamber positioned internally of said first chamber, said second chamber defined by an internal housing; said internal housing having an inlet and an outlet; said internal housing inlet is defined by at least one opening, said outlet is in operative communication with said exhaust;
said outer housing and said internal housing are spaced apart to create a first airflow path; said internal housing creating a second airflow path in said second chamber; said inlet in said internal housing is in fluid communication with said first airflow path;
whereby air with entrained particulates is pulled into said intake and flows about said first airflow path with particulate engaging said outer housing, said air then enters said inlet and flows about said second airflow path with any entrained particulates engaging said second housing and being pulled out of said exhaust.

2. The spark arrestor of claim 1, wherein said outer housing is generally cylindrical.

3. The spark arrestor of claim 1, wherein said intake is an elongated opening.

4. The spark arrestor of claim 1, wherein said internal housing is generally cylindrical.

5. The spark arrestor of claim 1, wherein said inlet is defined by a plurality of spaced openings.

6. The spark arrestor of claim 5, wherein said spaced openings are spaced slots.

7. The spark arrestor of claim 6, wherein said internal housing is generally cylindrical and said spaced slots extend longitudinally along said housing.

8. The spark arrestor of claim 7, wherein said slots have a center portion extending to opposed ends, said center portion being wider than said opposed ends, said center portion narrowing to said opposed ends.

9. The spark arrestor of claim 1, wherein said intake is partially closed by a plate to partially restrict said opening;
said plate being spaced from the opening of said intake;
whereby air entering said intake is accelerated at said plate.

10. The spark arrestor of claim 1, wherein said inlet is spaced from said intake by about 270°.

11. An air filter system comprising:
a filter unit with filter media;
a spark arrestor, said spark arrestor having a first chamber defined by an outer housing; said outer housing having an intake and an exhaust;
a second chamber positioned internally of said first chamber, said second chamber defined by an internal housing; said internal housing having an inlet and an outlet; said internal housing inlet is defined by a plurality of openings, said outlet is in operative communication with said exhaust;
said outer housing and said internal housing are spaced apart to create a first airflow path; said internal housing creating a second airflow path in said second chamber; said inlet in said internal housing is in fluid communication with said first airflow path;
said exhaust being in fluid communication with said filter unit;
whereby air with entrained particulates is pulled into said intake and flows about said first airflow path with particulate engaging said outer housing, said air then enters said inlet and flows about said second airflow path with any entrained particulates engaging said second housing and being pulled out of said exhaust and into said filter unit.

12. The air filter system of claim 11, wherein said outer housing is generally cylindrical.

13. The air filter system of claim 11, wherein said intake is an elongated opening.

14. The air filter system of claim 11, wherein said internal housing is generally cylindrical.

15. The air filter system of claim 11, wherein said inlet is defined by a plurality of spaced slots.

16. The air filter system of claim 15, wherein said internal housing is generally cylindrical and said spaced slots extend longitudinally along said housing.

17. The air filter system of claim 16, wherein said slots have a center portion extending to opposed ends, said center portion being wider than said opposed ends, said center portion narrowing to said opposed ends.

18. The air filter system of claim 10, wherein said intake is partially closed by a plate to partially restrict said opening;
said plate being spaced from the opening of said intake;
whereby air entering said intake is accelerated at said plate.

19. The air filter system of claim 10, wherein said inlet is spaced from said intake by about 270°.

20. A method for filtering air with entrained particulates, said method comprising:
providing a filter unit with filter media; said filter unit having a blower and fan;
providing a spark arrestor, said spark arrestor having a first chamber defined by an outer housing, said outer housing having an intake and an exhaust; a second chamber positioned internally of said first chamber, said second chamber defined by an internal housing, said internal housing having an inlet and an outlet, said internal housing inlet is defined by a at least one opening, said outlet is in operative communication with said exhaust, said outer housing and said internal housing are spaced apart to create a first airflow path; said internal housing creating a second airflow path in said second chamber; said inlet in said internal housing is in fluid communication with said first airflow path; said exhaust being in fluid communication with said filter unit;
said blower and fan pulling air with entrained particulates into said intake, forcing said air with entrained particulates into said first airflow path, said particulates colliding with said outer housing, said air with entrained particulates then being pulled into said inlet and forced about said second airflow path with entrained particulates being forced into said internal housing;
pulling said air through said exhaust into said filter unit.

21. The method of claim 20, wherein said air with entrained particulates is pulled into said outer housing and forced in a generally cylindrical airflow path in said first airflow path.

22. The method of claim 21, wherein said air with entrained particulates is pulled into said internal housing and forced in a generally cylindrical airflow path in said second airflow path.

23. The method of claim 20, wherein the air is pulled at about 270° from said intake before encountering said inlet.
